(19) United States
(12) Patent Application Publication
(10) Pub. No.: US 2012/0001042 A1
(43) Pub. Date: Jan. 5, 2012

(54) Hanger Mounted on a Wall

(75) Inventor: Xiaowen Zhong, Guangdong (CN)

(73) Assignee: GARBATH HOUSEWARE CO., LTD., Jiangmen City, Guangdong (CN)

(21) Appl. No.: 13/143,969

(22) PCT Filed: Nov. 30, 2009
(86) PCT No.: PCT/CN2009/075203

§ 371 Date: Jul. 11, 2011

(30) Foreign Application Priority Data
Mar. 17, 2009 (CN) 200920301338.5

(51) Int. Cl. F16M 13/02

(52) U.S. Cl. 248/222.14; 248/205.1

(57) ABSTRACT

The present invention discloses a hanger to be fixed on wall, comprising a cover, a housing and a fixing piece, wherein the housing is provided with a through hole therein, across which the fixing piece is fixedly connected to the cover, a groove is formed between the housing and the cover for suspending articles. The hanger further comprises a circumferential positioning apparatus between the housing and the fixing piece. The hanger disclosed by the present invention can be used on both the smooth and rough wall surfaces, thereby having a much wider application area; and because of the circumferential positioning apparatus, mounting and fixing of the hanger become much easier; the hanger has a simple structure, its rear cover can effectively prevent the articles hanged from falling, it is thus good for use.

### Field of the Invention

The present invention relates to a hanger, and more particular to a hanger to be fixed on wall for suspending articles.

### Description of Prior Art

In daily lives people would like to hang or fix some small articles on walls, in particular in kitchens, washing rooms or like where space is small, to save more space as well as for easy access. At present, in market a hanger to be secured on wall through a sucker attached usually comprises a housing and a sucker, wherein the sucker is provided with a threaded rod, the housing is fixedly connected to the sucker through the threaded rod and a matched nut. However, during assembling the nut will drive the sucker to rotate simultaneously, resulting in difficulties in firmly attaching the sucker to the wall. In addition, this type of hangers has relatively strict requirements on application environment: they only can be used on the smooth and flat wall surfaces, inapplicable to the rough ones.

### SUMMARY OF THE INVENTION

To solve the abovementioned problems, the present invention provides a hanger with easier installation and wider application.

The technical solution according to the present invention for solving the technical problems is described as follows:

A wall hanger, comprising a housing, a cover, and a fixing piece, wherein, the housing is provided with a through hole therein, the fixing piece is fixedly connected to the cover across the through hole, the gap between the housing and the cover is defined as a groove on which articles are to be hung, a circumferential positioning apparatus is set between the housing and the fixing piece.

Preferably, the fixing piece may be a sucker with a threaded rod thereon, which is connected to a screw hole on the cover across the through hole.

Furthermore, the circumferential positioning apparatus comprises, on the outer margin of the sucker a plurality of projections, and on the inner margin of the housing a plurality of positioning grooves engaged with the positioning projections.

Preferable, the fixing piece may be a binding screw, of which tail is connected to a screw hole on the cover across the through hole, the housing is provided with a plurality of mounting holes on the periphery thereof, screws are used to fix the housing on the wall through the mounting holes.

Furthermore, the circumferential positioning apparatus comprises, on the middle of the binding screw a polygonal projection, and on the inner side of the through hole a polygonal groove engaged with the polygonal projection.

The advantages of the present invention is as: the wall hanger disclosed by the present invention could be used on both the smooth and rough wall surfaces, thereby having a much wider application area; and because of the circumferential positioning apparatus, mounting and fixing of the hanger become much easier as well. The hanger has a simpler structure; its rear cover can effectively prevent the articles hanged on the grove from falling, convenient for use.

### BRIEF DESCRIPTION OF THE DRAWINGS

FIG. 1 is an exploded view of a hanger of the first embodiment according to the present invention;

FIG. 2 is a side view of the hanger of the first embodiment;

FIG. 3 is a schematic view showing the state of use of the hanger of first embodiment;

FIG. 3 is an exploded view of a hanger of the second embodiment according to the present invention;

FIG. 5 is a schematic view of the housing in the second embodiment.

### DESCRIPTION OF THE PREFERRED EMBODIMENT

The present invention provides a hanger to be fixed on wall, comprising a housing 1, a cover 2 and a fixing piece, wherein the housing 1 is provided with a through hole 11, the fixing piece is fixedly connected to the cover 2 across the through hole 11, the gap between the housing 1 and the cover 2 is defined as a groove 6 on which the small articles are to be hanged. The cover 2 and the housing 1 may have a similar size, thus the cover 2 could effectively prevent the articles hanged on groove 6 from falling. The hanger furthers comprises a circumferential positioning apparatus between the housing 1 and the fixing piece.

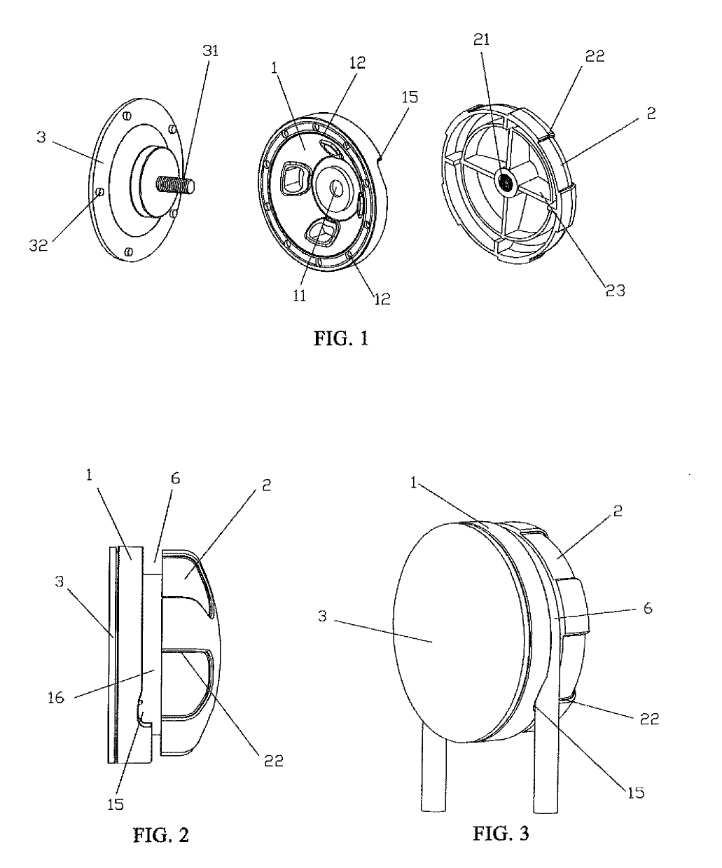

As shown by FIGS. 1 to 3, in the first embodiment of the present invention, the fixing piece may be a sucker 3 with a threaded rod 31 thereon, wherein across the though hole 11 the threaded rod 31 is screwed in the cover 2 through a screw hole 21. The circumferential positioning apparatus includes several positioning projections 32 set on the outer margin of the sucker 3, and several positioning grooves 12 set on the inner margin of the housing 1 engaged with the positioning projections 32. In the first embodiment the hanger is fixed on the wall by the sucker 3 sticking to the surface of the wall, and thus applicable for a smooth and flat wall surface. in use, through rotating the cover 2 to tighten up the housing 1, the sucker is pressed to stick to the wall surface, the whole hanger is thus secured. Meanwhile, during the process of rotating the cover 2, the circumferential positioning apparatus could prevent the sucker 3 from rotating with the cover 2, allowing the sucker 3 to stick to the wall quickly.

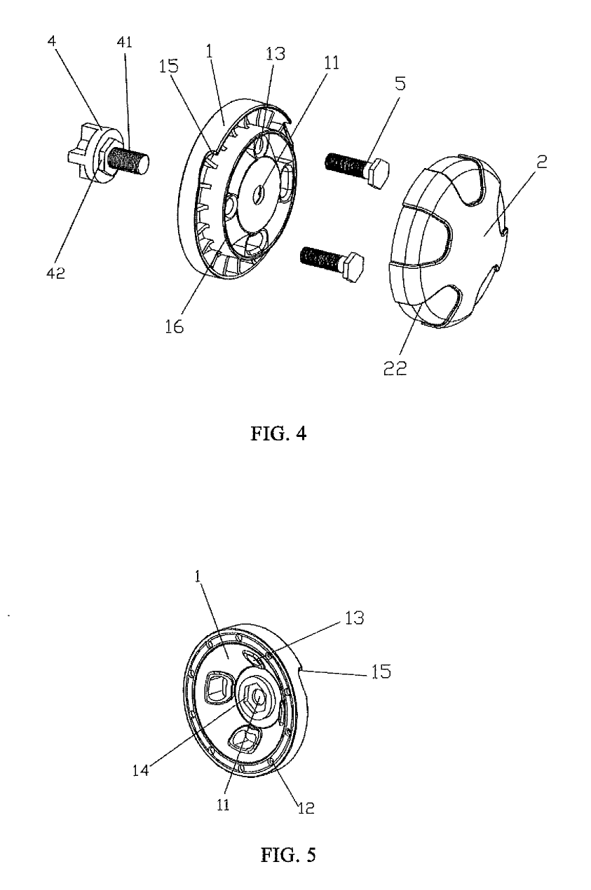

FIGS. 4 and 5 illustrate the second embodiment of the present invention, wherein the fixing device may be a binding screw 4, of which tail 41 is fixedly connected to the cover 2 by the screw hole 21 across the through hole 11. The housing 1 further has a plurality of mounting holes 13, screws 5 are used to secure the housing 1 on the wall through the mounting holes 13. The mounting holes 13 may be equably distributed around the through hole 11 on the housing 1, to gain a more stable mounting structure. The binding screw 4 is clamped by the wall and the housing 1, and so fixed. In this embodiment, the circumferential positioning apparatus is set between the housing 1 and the binding screw 4, and includes a polygonal projection 42 on the middle of the binding screw 4 and a matched polygonal groove 14 on the inner side of the through hole 11. Preferably, the polygonal projection 42 and the matched polygonal groove 14 are designed into hexagons, for convenience in manufacturing. The hanger in the second embodiment can be used with an irregular wall surface; its fixing method is sample but effective, and suitable for suspending relatively heavy articles.

In addition, the housing 1 has a concave portion on the outer edge thereof forming a wire groove 15, allowing the wire or rope hanged on the groove 6 to go through, as well as not to sway. Furthermore, several flanges 22 are set on the outer surface of the cover 2, for adding extra friction for rotating the cover 2. The cover 2 further has several reinforcing ribs 23 inside, to enhance its structural strength and so as not to deform and damage easily. The housing 1 further has a rim 16 extending from the middle thereof, cooperated with the cover 2 to define the width of the groove 6.

Because it will be readily apparent to those skilled in the hanger art that innumerable variations, modifications, applications, and extensions of the principles hereinbefore set forth can be made without departing from the spirit and the scope of the invention, what is hereby defined as such scope and is desired to be protected should be measured, and the invention should be limited, only by the claims.

1. A wall hanger, comprising a housing, a cover, and a fixing piece, wherein said housing is provided with a through hole therein, said fixing piece being fixedly connected to said cover across said through hole, the gap between said housing and said cover being defined as a groove on which articles are to be hung, said hanger further comprising a circumferential positioning apparatus set between said housing and said fixing piece.

2. The hanger according to claim 1, wherein said fixing piece may be a sucker with a threaded rod thereon, which is connected to a screw hole on said cover across said through hole.

3. The hanger according to claim 2, wherein said circumferential positioning apparatus comprises, on the outer margin of said sucker a plurality of projections, and on the inner margin of said housing a plurality of positioning grooves engaged with said positioning projections.

4. The hanger according to claim 1, wherein said fixing piece may be a binding screw, of which tail is connected to a screw hole on the cover across said through hole, said housing being provided with a plurality of mounting holes on the periphery thereof, screws being used to fix said housing on the wall through the mounting holes.

5. The hanger according to claim 4, wherein said circumferential positioning apparatus comprises, on the middle of said binding screw a polygonal projection, and on the inner side of said through hole a polygonal groove engaged with said polygonal projection.

6. The hanger according to claim 1, wherein said housing has a concave portion on the outer edge thereof, forming a wire guide.

7. The hanger according to claim 1, wherein said housing has a rim extending from the middle thereof.

8. The hanger according to claim 1, wherein said cover has flanges on the outer surface thereof for holding on.
